(19) United States
(12) Patent Application Publication
(10) Pub. No.: US 2025/0178949 A1
(43) Pub. Date: Jun. 5, 2025

(54) ULTRA-COOL AND THERMOCHROMIC ROOF AND SIDING COATINGS

(71) Applicant: Eagle Eye Research, Inc., Durham, NC (US)

(72) Inventor: John H Reif, Durham, NC (US)

(21) Appl. No.: 18/841,186

(22) PCT Filed: Feb. 22, 2023
(86) PCT No.: PCT/US2023/062990

§ 371 Date: Aug. 23, 2024

Related U.S. Application Data
(60) Provisional application No. 63/313,860, filed on Feb. 25, 2022.

(51) Int. Cl. C03C 8/20; C03C 8/14

(52) U.S. Cl. CPC C03C 8/20; C03C 8/14; C03C 2205/00

(57) ABSTRACT

A nanoparticle-impregnated coating for roofs and sidings that provides for highly effective radiative cooling of a building. The coating may be vitreous enamel coating. The use of multiscale nanoparticles include one or more of titanium dioxide, barium sulfate, zirconium silicate, hexagonal boron nitride, calcium carbonate, zinc sulfide, silicon dioxide, magnesium oxide, yttrium orthoaluminate, calcium oxide, magnesium aluminate, lanthanum aluminate to provide one or more of a very high optical reflectance and optical emissivity, and span the entire frequency band of ground-level solar irradiation. These substrate surfaces include metal roofing and siding materials such as steel, corrugated iron, cast iron, aluminum, zinc, tin, copper as well as metal admixtures and also metal substrates with metallic coatings, or nonmetal roofing of clay, terracotta, ceramic tile, brick, fiber cement, concrete, and stone such as slate, as well as admixtures of these materials.

### CROSS-REFERENCE TO RELATED APPLICATIONS

This application claims one or more inventions which were disclosed in Provisional Application No. 63/313,860, filed Feb. 25, 2022, entitled “ULTRA-COOL AND THERMOCHROMIC ROOF AND SIDING COATINGS”. The benefit under 35 USC § 119 (e) of the United States provisional application is hereby claimed, and the aforementioned application is hereby incorporated herein by reference.

### BACKGROUND

The present invention relates to roof and siding coatings, and more specifically to ultra-cool and thermochromic roof and siding coatings.

Considerable electrical energy is used to cool buildings by air-conditioning systems in developed nations. In undeveloped nations, the lack of cooling of buildings has a major impact on large numbers of individuals' health and well-being as well as worker productivity. Passive cooling technologies have been developed to cool buildings without the use of energy, but it remains a major challenge to develop passive cooling technology with moderate cost, high effectiveness, and durability.

Radiative cooling is a type of passive cooling where a building is cooled by its roof and siding's radiation to the sky of its emitted solar energy. Even in periods of direct sunlight, radiative cooling can allow the outer surfaces of passively cooled roof and sidings to reach below-ambient air temperatures.

The solar sky window is the frequency band of solar irradiation at a given elevation on the Earth. At sea level, the bulk of the solar sky window ranges from ultraviolet (UV) of approximately 300 nm to infrared (IR) of approx. 2,500 nm, with most of the solar energy in the IR range. A key challenge is to develop coatings for the roof and sidings of buildings that provide a high degree of radiative cooling over the entire solar sky window of UV to IR at the elevation of the buildings. Within the solar sky window, the total solar irradiation is composed of 48% in the near IR (NIR) spectrum, 45% in the visible spectrum, region, and 7% from the UV radiation.

It is noted that the terms optical emissivity and optical reflectance used within the application refer to the emissivity and reflectance over the entire solar sky window, rather than just the visual spectrum. Emissivity is the ratio of the thermal radiation of a surface relative to the radiation of an ideal back body at the same temperature, with the ratio between 0 and 1, with an emissivity of 0 indicating that the material is a perfect reflector and an emissivity of 1 indicating a perfect emitter. The solar reflectance ratio is the ratio between the solar energy globally reflected by a surface and the total incident solar energy. Key criteria of a radiative cooling coating are emissivity and the solar reflectance ratio within the frequency band of ground-level solar irradiation, as well as the cost, durability and toxicity of the coating.

An ultra-cool radiative cooling coating should have both a very high optical emissivity and a very high optical reflectance ratio over the entire solar sky window. Various coatings such as paints, epoxies, and polyethylene aerogels have been proposed for ultra-cool radiative cooling of roofs and sidings, but their durability is limited.

Some geographic locations experience significant daily and seasonal changes in solar irradiation and ambient temperatures. Particularly in the summer and during the day, that location may experience high temperatures due to solar irradiation, and benefit from radiative cooling from the roof and sidings. Whereas, particularly in the winter and during the night, that location may experience low temperatures, and benefit from radiative absorptance from the roof and sidings. It is a challenge to provide roof and siding coatings whose radiative cooling and radiative absorptance properties vary with temperature.

Vitreous enamel (also termed porcelain enamel) is a highly durable material. Its advantages include high resistance to weathering, abrasion, and chemicals, as well as mechanical hardness. The thickness of conventional vitreous enamel generally ranges from 0.3 mm to 1.3 mm. Vitreous enamel can be made by fusing a powder known as the frit, composed primarily of silica (silicon dioxide) as well as other materials, to a substrate by firing at a high temperature of 730° C. and 870° C.

Generally, a frit consists of various oxides; these include adherence oxides, refractories, and fluxes. Adherence oxides, such as cobalt oxide (CoO), nickel oxide (NiO), and copper (II) oxide (CuO), provide adherence to the substrate surface. Refractories, such as silicon dioxide (SiO₂) and aluminum oxide (Al₂O₃), are acidic glass-forming oxides that provide body to the vitreous enamel; they also increase viscosity and chemical resistance. Fluxes, such as boric oxide (B₂O₃), sodium oxide (Na₂O), potassium oxide (K₂O), lithium oxide (Li₂O), and zinc oxide (ZnO), are alkaline oxides that react with the refractories and also lower the softening temperature of glass to aid in the production of the vitreous enamel matrix as well as increase surface hardness. Both refractories and fluxes also reduce the expansion coefficient, decreasing cracking.

All content percentages stated here are with respect to weight; a stated percentage ingredient of the frit is with respect to the total weight of the frit; and a stated percentage ingredient of the substrate is with respect to the weight of the substrate.

The frit composition in practice depends on the substrate surface and whether the enamel will be a ground coat or cover coat of the substrate surface. There are generally multiple acceptable frit compositions used in practice, as described below, for frits without opacifiers and color oxides.

For a sheet steel ground coat, a frit batch can be 25% feldspar, 35% borax, 20% quartz, 6.5% soda ash, 4% soda nitre, 7% fluorspar, 0.5% cobalt oxide, 0.5% nickel oxide, and 1.5% tin oxide. Alternatively, again for sheet steel ground coat, the frit batch can be 20.4% feldspar, 35.8% borax, 17.7% quartz, 5.3% soda ash, 4.5% soda nitre, 4.9% fluorspar, 6.5% barium carbonate, 2.4% sodium sil. fluoride, 0.5% cobalt oxide, 0.5% nickel oxide, and 1.5% tin oxide.

For sheet steel cover coat, a frit batch can be 27% feldspar, 25% borax, 24% quartz, 4.1% soda ash, 6% soda nitre, 4.4% fluorspar, 11% cryolite, and 6% antimony oxide. Alternatively, again for sheet steel cover coat, a frit batch can be 22.8% feldspar, 23.1% borax, 21.1% quartz, 6.3% soda ash, 3% soda nitre, 3.4% fluorspar, 10.1% cryolite, and 6.8% sodium antimonate, and 3.4% zinc oxide.

The substrate surface to which vitreous enamel may be applied may be a metal, such as steel, corrugated iron, cast iron, aluminum, zinc, tin, copper, as well as metal admixtures and also metal substrates with metallic coatings.

Steels used for enameling generally contain less than 0.20% carbon, which reduces blistering of enamel. Specialty steel substrate surfaces developed as substrates for vitreous enamel include: decarbonized enameling steel (used for one-stage enamel coating), interstitial-free enameling steel (moderately low-carbon steel, but stronger), cold-rolled aluminum steel (low-carbon steel), and cold-rolled rimmed steel (a low quality steel resulting in lower quality vitreous enamel).

Enameling iron is a premium grade of nearly pure iron with very low carbon content, but it requires two stages of enamel firing. Cast iron has a carbon content of at least 2.06%, and generally between 3.25% to 3.60% carbon, and to promote enameling additional chemicals including carbon, silicon, phosphorus, manganese, and sulfur are generally provided.

Alternatively, the substrate surface may not be a metal, but instead clay, pottery, earthenware, stoneware, terracotta, ceramic tile, brick, fiber cement, concrete, or stone such as slate. In these cases, a coating applied to the substrate surface is generally termed a ceramic glazing. The composition of a standard ceramic glazing frit can considerably vary; an example frit composition is 24.03% basalt, 14.68% Na-feldspar, 2.89% sodium carbonate (Na₂CO₃), 10.26% boric acid, 5.97% ZnO, 4.42% calcium carbonate (CaCO₃), 14.43% zirconium (IV) silicate (ZrSiO₄), 20.32% opalite, 2.80% barium sulfate (BaSO₄), 0.96% potassium nitrate (KNO₃).

The production of vitreous enamel can be done in multiple stages, some of which are optional.

The substrate surface is first generally prepared by the application of various substances, such as degreasers in the case of metal substrate surfaces, pickling (which etches metal substrate surface, providing anchoring points for the vitreous enamel), pH neutralization, and rinsing. There also may be a possible preliminary firing of a ground coat (also termed an undercoat), to further promote adherence to the substrate.

After this preparation of the substrate surface, the primary frit may be applied to the substrate surface by a variety of dry and wet techniques, each requiring specialized frit composition. A dry application technique is electrostatic deposition, where an organic silane that can hold an electrical charge encapsulates the dry frit, allowing electrostatic adherence to the substrate surface. A wet application technique techniques is flow coating, where a slurry of the frit is flowed over the surface of the substrate surface.

For dry process cast iron cover enamel coat, a frit batch can be 34.3% feldspar, 19.3% borax, 7.7% soda ash, 2.6% soda nitre, 7.3% fluorspar, 3.4% cryolite, 9.2% zinc oxide, 8.1% red lead, 8.1% tin oxide.

For wet process cast iron cover enamel coat, a frit batch can be 23% feldspar, 24% borax, 12% quartz, 8% soda nitre, 2% fluorspar, 6% cryolite, 10% barium carbonate, 4% sodium sil. fluoride, 6% zinc oxide, 10% boric acid, and 8% antimony oxide.

After application of the frit to the substrate surface, a primary firing at a temperature of approximately 750° C.-850° C. fuses the frit to the substrate to form the primary coat.

The duration of the primary firing and the temperature depends on the substrate surface. Aluminum enamels are fired for 10 minutes at 538°-593° C. Dry process cast iron is fired for 5 minutes at 816°−927° C. Wet process cast iron is fired for 10-20 minutes at 732°−816° C. Sheet iron ground coat is fired for 1-4 minutes at 760°−871° C.

Subsequent to this primary firing that fuses the frit to the substrate, there may be subsequent firings using additional frits to assemble layers of vitreous enamel of distinct composition over the primary coat. For example, after a sheet iron ground coat is fired, a sheet iron cover coat is fired for 1-3 minutes at 816°−927° C.

### SUMMARY

In the present invention, highly reflective nanoparticle-impregnated vitreous enamel coatings are applied to a substrate surface to provide high reflectivity over the range of solar irradiation within the solar sky window. The highly reflective nanoparticles (HRNPs) have high melting points and reflectivity to allow for firing without significant change in their reflectivity.

In one embodiment, the HRNPs include one or more of: barium sulfate (BaSO₄), hexagonal boron nitride (h-BN), zirconium silicate (ZrSiO₄), titanium dioxide (TiO₂), calcium carbonate (CaCO₃), zinc sulfide (ZnS), silicon dioxide (SiO₂), magnesium oxide (MgO), yttrium orthoaluminate (Al₅O₁₂Y₃), calcium oxide (CaO), magnesium aluminate (Al₂MgO₄), and lanthanum aluminate (LaAlO₃).

The reflectivity of HRNPs depend on the size and chemistry of the particular mix of nanoparticles. In embodiments of the present invention, the HRNPs are multi-scale with a distribution of sizes to provide high reflectivity over the full range of solar irradiation. For example, the larger sizes provide reflectivity of IR, whereas the smaller sizes provide reflectivity of UV. The present invention employs a selection of a distribution of multiple sizes of HRNPs, where the selection of HRNPs and their sizes is optimized in insure the distribution of high reflectivity over the range of solar irradiation frequencies.

In one embodiment of the present invention, the size ranges of the multi-scale HRNPs is continuous from smallest to largest. In other embodiment of the present invention, the size ranges of the multi-scale HRNPs is discrete; the mix of multi-scale HRNPs is formed from two or more batches of HRNPs of uniform size.

In the present invention, the frit includes multi-scale HRNPs to create a specialized vitreous enamel. The frit is fired at a temperature below the melting temperature of the HRNPs, such that high optical emissivity and reflectance ratio are preserved in the resulting HRNPs-impregnated vitreous enamel coating. The vitreous enamel coating is highly durable with a lifespan of approximately 40 to 50 years, vastly exceeding the lifespan of other roof and siding coatings that might be used for radiative cooling, such as paints, epoxies, and polyethylene aerogels.

Embodiments of the HRNPs-impregnated vitreous enamel of the present invention can be fired on metal substrate surfaces including steel, corrugated iron, cast iron, aluminum, zinc, tin, copper as well as metal admixtures and also metal substrates with metallic coatings. Embodiments of HRNPs-impregnated vitreous enamel of the present invention can also be fired on nonmetal roofing and siding materials such as such as clay, terracotta, ceramic tile, brick, fiber cement, concrete, and stone such as slate, as well as admixtures of these materials.

A vitreous enamel coating, depending on the thickness of the coating, comprises 2-40% of one or more highly reflective multi-scale nanoparticles of a total weight of the vitreous enamel coating.

### BRIEF DESCRIPTION OF THE DRAWINGS

FIG. 1 shows solar irradiation onto a roof with reflectance.

FIG. 2 shows a section of the vitreous enamel including multi-scale, distributed sized highly reflective nanoparticles.

FIG. 3 shows a flowchart of a method or applying an enamel coating to a substrate surface.

### DETAILED DESCRIPTION

The terminology used herein is for the purpose of describing particular embodiments only and is not intended to be limiting of the invention. As used herein, the singular forms “a,” “an,” and “the” are intended to include the plural forms as well as the singular forms, unless the context clearly indicates otherwise. It will be further understood that the terms “comprises” and “comprising,” when used in this specification, specify the presence of stated features, steps, operations, elements, and components, but do not preclude the presence or addition of one or more other features, steps, operations, elements, components, and groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

All content percentages stated here are with respect to weight; a stated percentage ingredient of the frit is with respect to the total weight of the frit; and a stated percentage ingredient of the substrate is with respect to the weight of the substrate.

Novel types of vitreous enamel are discussed herein. In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention; it is not intended to limit the invention to the specific embodiments illustrated by the figures or description below.

Embodiments of the present invention describe novel types of vitreous enamel which contain multi-scale highly reflective nanoparticles. This vitreous enamel can be fired on many metal substrate surfaces including steel, corrugated iron, cast iron, aluminum, zinc, tin, copper as well as metal admixtures and also metal substrates with metallic coatings. Furthermore, this vitreous enamel can be fired on many nonmetal roofing and siding materials such as such as clay, terracotta, ceramic tile, brick, fiber cement, concrete, and stone such as slate, as well as admixtures of these materials.

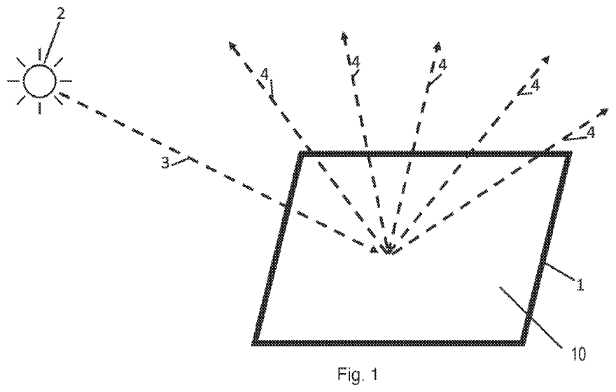

FIG. 1 shows solar irradiation onto a roof with reflectance. The roof 1 preferably has a vitreous enamel coating 10 of an embodiment of the present invention. The vitreous enamel coating 10 receives solar irradiation 3 from the sun 2. Due to the vitreous enamel coating 10, the solar irradiation is reflected 4.

Embodiments of the present invention employs highly reflective nanoparticles (HRNPs), which have melting points that are high enough such that the reflectivity of the HRNPs are not compromised during the firings associated with applying the vitreous enamel coating to a substrate surface.

The HRNPs included in the vitreous enamel coatings preferably include a distribution of sizes of the nanoparticles. The distribution of sizes of nanoparticles used provides high reflectivity over the full range of solar irradiation from IR to UV.

Nanoparticles used in embodiments of the present invention are of a size less than 2000 nm. In many cases, a nanoparticle of a particular size and composition will have an emission and reflectance spectra limited to a restricted frequency band. In embodiments of the present invention no single size of nanoparticles is to be exclusively used. The term “multi-scale nanoparticles” used herein is to designate a collection of nanoparticles where the nanoparticles have a distribution of sizes or nanoparticles of multiple sizes.

In one embodiment, the HRNPs include one or more of: barium sulfate (BaSO₄), hexagonal boron nitride (h-BN), zirconium silicate (ZrSiO₄), titanium dioxide (TiO₂), calcium carbonate (CaCO₃), zinc sulfide (ZnS), silicon dioxide (SiO₂), magnesium oxide (MgO), yttrium orthoaluminate (Al₅O₁₂Y₃), calcium oxide (CaO), magnesium aluminate (Al₂MgO₄), and lanthanum aluminate (LaAlO₃).

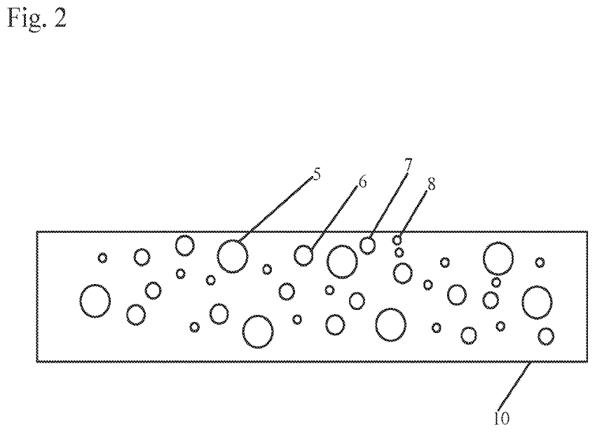

The distribution of sizes associated with exemplary HRNPs is shown below in Table 1. FIG. 2 shows a section of the vitreous enamel 10 including multi-scale, distributed sized highly reflective nanoparticles 5-8.

TABLE 1

| Nanoparticle | Size Range | |
|---|---|---|
| titanium dioxide (TiO₂) | 140-600 | nm |
| barium sulfate (BaSO₄) | 10-530 | nm |
| zirconium silicate (ZrSiO₄) | 160-550 | nm |
| hexagonal boron nitride (h-BN) | 140-525 | nm |
| calcium carbonate (CaCO₃ | 10-80 | nm |
| titanium dioxide (TiO2) | 8-27 | nm |
| zinc sulfide (ZnS) | 2-40 | nm |
| silicon dioxide (SiO₂) | 10-20 | nm |
| magnesium oxide (MgO) | 10-50 | nm |
| yttrium orthoaluminate (YAlO₃) | 25-50 | nm |
| calcium oxide (CaO) | 10-70 | nm |
| magnesium aluminate | 6-26 | nm |
| (MgAl₂O₄), | | |
| lanthanum aluminate (LaAlO₃) | <180 | nm |

These materials are not hazardous by the existing OSHA Hazard Communication Standard and have much low toxicity compared to other nanoparticles such as carbon nanotube nanoparticles.

In one embodiment, the one or more multi-scale HRNPs has a distribution of nanoparticles of 10-900 nm.

It is also noted that multi-scale nanoparticles with a broad distribution of particle sizes can provide a much wider frequency band spectrum of optical emission and reflectance. For example, a barium sulfate (BaSO₄) nanoparticle size distribution between 170 nm to 530 nm provides a phonon resonance at 9 μm, which results in a very high optical emissivity (approx. 96%) and optical reflectance (approx. 97.6%) within the full frequency band of the solar sky window of ground-level solar irradiation. A hexagonal boron nitride (h-BN) nanoparticle size distribution between 140 nm and 525 nm provides an optical emissivity (approx. 83%) and optical reflectance (approx. 97.9%) within the full frequency band of the solar sky window of ground-level solar irradiation. A titanium dioxide (TiO₂) nanoparticle size distribution between 140 nm and 600 nm provides an optical emissivity (approx. 92%) and optical reflectance (approx. 95%) within the full frequency band of the solar sky window of ground-level solar irradiation. A zirconium silicate (ZrSiO₄) nanoparticle size distribution between 160 nm and 550 nm provides an optical emissivity (approx. 95%) and optical reflectance (approx. 97%) within the full frequency band of the solar sky window of ground-level solar irradiation.

In some embodiments, thermochromic materials are added. Thermochromic materials exhibit a phase change in optical properties due to changes in temperature. Vanadium dioxide (VO₂) is a thermochromic material that is transparent to IR at less than 68° C., and has a phase change to reflective to IR at or above 68° C. Vanadium dioxide nanoparticles provide particularly favorable thermochromic properties. The phase change temperature of vanadium dioxide can be lowered by doping the material with various materials, including tungsten, magnesium, and molybdenum. For example, 1.9% of tungsten lowers the phase change temperature to 29° C.

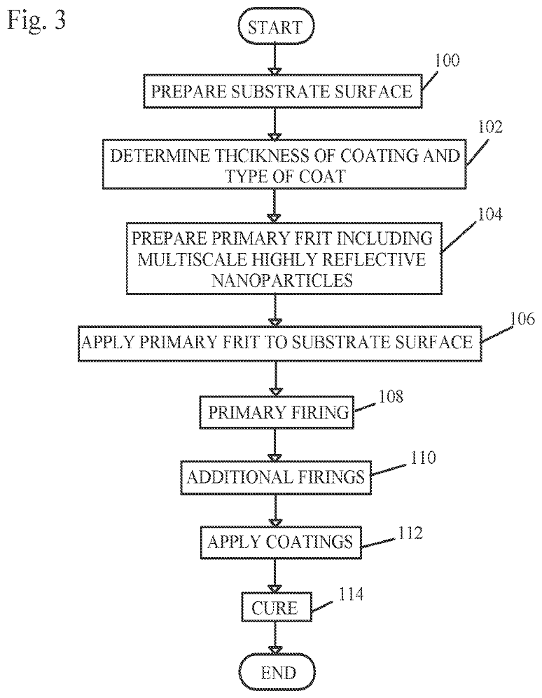

FIG. 3 shows a flowchart of a method or applying an enamel coating to a substrate surface.

In a first step, a substrate surface is prepared (step 100). The substrate surface may be a metal, such as steel, corrugated iron, cast iron, aluminum, zinc, tin, copper, as well as metal admixtures and also metal substrates with metallic coatings. Alternatively, the substrate surface may not be a metal, but instead clay, pottery, earthenware, stoneware, terracotta, ceramic tile, brick, fiber cement, concrete, or stone such as slate. Depending on the substrate surface, the application of various substances, such as degreasers in the case of metal substrate surfaces, pickling (which etches metal substrate surface, providing anchoring points for the vitreous enamel), pH neutralization, and rinsing. There also may be a possible preliminary firing of a ground coat (also termed an undercoat), to further promote adherence to the substrate.

Next, a thickness of the coating on the substrate surface is determined as well as whether the coating is to a ground coating/undercoat, cover coat or a primary coating (step 102). A cover coat is a coat that cannot be applied directly to a substrate surface, but instead needs to be applied to a ground coat. A ground coat is a first coat that is applied directly to the substrate surface and promotes adherence of subsequent coats. Some ground coats do not require additional coats.

The type of coat determines the composition of the frit, the temperature of the primary firing, the temperature and the need for any additional firings. In general, the type of coat does not determine whether a wet or dry technique is used to apply the frit, though in the wet process, clay may be added to the primary frit.

The thickness of the coating determines the percentage of nanoparticles to be added to the frit in the subsequent step. Conventionally, the thickness of vitreous enamel is 0.3-1.33 mm with an average thickness of 0.8 mm. In an embodiment of the invention, for a range of thickness of the enamel coating of 0.3-1.33 mm, 5-15% nanoparticles are added to the frit.

If the thickness of the enamel coating were to increase, the percentage of nanoparticles of the frit decreases linearly. For example, for a thickness of 1.2 mm, 3.3-10% of nanoparticles would be required.

If the thickness of the enamel coating were to decrease, the percentage of nanoparticles of the frit increases linearly. Therefore, for a thickness of 0.4 mm, the percentage of nanoparticles required would be 10-30%.

The above thickness and percentages of multi-scale HRNPs can vary outside of the examples given above. In one embodiment, the vitreous enamel coating comprises 2-40% of one or more highly reflective multi-scale nanoparticles of a total weight of the vitreous enamel coating.

A primary frit including multi-scale HRNPs is then prepared (step 104). It is noted that no single size of nanoparticles is exclusively used. A distribution of sizes, preferably in the range of 170-530 nm of nanoparticles are incorporated into the primary frit. The primary frit is prepared by fusing a variety of minerals in a furnace and then rapidly quenching the molten material to obtain granules which are then dried.

In one embodiment the frit consists of various oxides; these include adherence oxides, refractories, fluxes, opacifiers, colors, and multi-scale HNRPs. Adherence oxides, such as CoO, NiO, and CuO, provide adherence to the substrate surface. Refractories, such as SiO₂ and Al₂O₃, are acidic glass-forming oxides that provide body to the vitreous enamel; they also increase viscosity and chemical resistance. Fluxes, such as B₂O₃, Na₂O, K₂O, Li₂O, and ZnO, are alkaline oxides that react with the refractories and also lower the softening temperature of glass to aid in the production of the vitreous enamel matrix; they also increase surface hardness. Both refractories and fluxes also reduce the expansion coefficient, decreasing cracking. Opacifiers, such as ZIO₂, Sb₂O₃, TiO₃, and P₂O₅, can be added to produce opacity (increased whiteness) and improve resistance to acids.

The multi-scale HNRPs added to the frit can include, but are not limited to an admixture of: barium sulfate (BaSO₄), hexagonal boron nitride (h-BN), zirconium silicate (ZrSiO₄), titanium dioxide (TiO₂), calcium carbonate (CaCO₃), zinc sulfide (ZnS), silicon dioxide (SiO₂), magnesium oxide (MgO), yttrium orthoaluminate (Al₅O₁₂Y₃), calcium oxide (CaO), magnesium aluminate (Al₂MgO₄), and lanthanum aluminate (LaAlO₃). The total percentage of the multi-scale HNRPs within the frit composition is between 5-30% of the total weight of the vitreous enamel.

In one embodiment, the multi-scale HNRPs consist entirely of only one type of nanoparticle, chosen from barium sulfate (BaSO₄), hexagonal boron nitride (h-BN), zirconium silicate (ZrSiO₄), titanium dioxide (TiO₂), calcium carbonate (CaCO₃), zinc sulfide (ZnS), silicon dioxide (SiO₂), magnesium oxide (MgO), yttrium orthoaluminate (Al₅O₁₂Y₃), calcium oxide (CaO), magnesium aluminate (Al₂MgO₄), and lanthanum aluminate (LaAlO₃).

In another embodiment, the multi-scale HNRPs in the frit are two types of nanoparticles, in relative percentage to optimize total reflectance over the solar window, wherein the two types of nanoparticles are chosen from barium sulfate (BaSO₄), hexagonal boron nitride (h-BN), zirconium silicate (ZrSiO₄), titanium dioxide (TiO₂), calcium carbonate (CaCO₃), zinc sulfide (ZnS), silicon dioxide (SiO₂), magnesium oxide (MgO), yttrium orthoaluminate (Al₅O₁₂Y₃), calcium oxide (CaO), magnesium aluminate (Al₂MgO₄), and lanthanum aluminate (LaAlO₃).

In a first example, if the substrate surface is a sheet steel and the coat to be applied is a ground coat with a thickness of 0.8 mm, the frit includes: 25% feldspar, 35% borax, 20% quartz, 6.5% soda ash, 4% soda nitre, 7% fluorspar, 0.5% cobalt oxide, 0.5% nickel oxide, 1.5% tin oxide and 5-15% of multi-scale HNRPs.

In another example, if the substrate surface is a sheet steel and the coat to be applied is a ground coat, the frit composition includes: 20.4% feldspar, 35.8% borax, 17.7% quartz, 5.3% soda ash, 4.5% soda nitre, 4.9% fluorspar, 6.5% barium carbonate, 2.4% sodium sil. fluoride, 0.5% cobalt oxide, 0.5% nickel oxide, 1.5% tin oxide and 5-15% of multi-scale HNRPs.

In another example, if the substrate surface is a sheet steel and the coat to be applied is a cover coat, the frit composition includes: cover coat with a thickness of 0.8 mm, the frit includes: 22.8% feldspar, 23.1% borax, 21.1% quartz, 6.3% soda ash, 3% soda nitre, 3.4% fluorspar, 10.1% cryolite, 6.8% sodium antimonate, and 3.4% zinc oxide, and 5-15% of multi-scale HNRPs.

The percentages of components of the frit are just examples and the frit composition in practice depends on the substrate surface and also depends on if it is a ground coat or cover coat.

The primary frit can be applied to the substrate surface (step 106) using a dry process or a wet process.

In the wet process, the primary frit is mixed with water to create an aqueous suspension. Additional floating agents are then added, such as clay. The primary frit is then applied to the substrate surface by immersion or spraying. The application of the wet frit can be through dip coating, flow coating, spray coating, electrostatic wet spray coating or electrophoretic coating. For example, in a wet process cast iron cover enamel coat, a frit batch can be 23% feldspar, 24% borax, 12% quartz, 8% soda nitre, 2% fluorspar, 6% cryolite, 10% barium carbonate, 4% sodium sil. fluoride, 6% zinc oxide, 10% boric acid, 8% antimony oxide, as well as multi-scale HRNPs.

In the dry process, the frit is ground in the absence of water and then applied to the substrate surface, for example through an electrostatic dry powder method. The frit is encapsulated in one or more organic compounds such as organic silane so that the particles of the organic compound acquire an electric charge and encapsulate the dry frit, such that the frit can be “sprayed” on the substrate surface, allowing for electrostatic adherence to the substrate surface. For example, in a dry process cast iron cover enamel coat, a frit batch can be 34.3% feldspar, 19.3% borax, 7.7% soda ash, 2.6% soda nitre, 7.3% fluorspar, 3.4% cryolite, 9.2% zinc oxide, 8.1% red lead, 8.1% tin oxide, as well as multi-scale HRNPs.

The substrate surface then undergoes primary firing (step 108). The duration and temperature of the firing is dependent upon the substrate surface type. Aluminum enamels are fired for approximately 10 minutes at 538-593° C. Dry process cast iron is fired for approximately 5 minutes at 816-927° C. Wet process cast iron is fired for approximately 10-20 minutes at 732-816° C. Sheet iron ground coats are fired for approximately 1-4 minutes at 760-871° C.

Optionally, additional firings can take place after the primary firing (step 110) with similar temperature and times depending on the desired thickness and other properties.

Coatings are then placed on the enamel covering the substrate surface (step 112). The coatings can be one or more of a resin/epoxy coating, or a clear coating. Other coatings can also be used.

After all coatings are complete, the substrate surface is cured (step 114) and the method ends. Curing takes place at a temperature of 230°−250° C.

It is noted that the firing temperatures of the frits of embodiments of the present invention are well below the melting temperature of the nanoparticles included. For example, the melting point of barium sulfate is 1,345° C., the melting point of titanium dioxide is 1,855° C., and the melting point of zirconium silicate is 1,540° C., well below the firing temperatures of less than 1000° C. Furthermore, the melting point of the nanoparticles being higher than the enamel coating, the high reflectance ratio and emissivity ratio of the nanoparticles are preserved in the resulting nanoparticle-impregnated vitreous enamel coating.

Embodiments of the present invention include a multi-scale nanoparticle-impregnated vitreous enamel coatings which include frits of an admixture of conventional frit materials, and multi-scale HRNPs. Additional thermochromic materials can be added, for example vanadium dioxide.

The present invention's HRNPs-impregnated vitreous enamel coatings can be fired on many substrates that include commonly used roofing and siding materials, including metallic materials such as corrugated iron, zinc, tin, steel, copper or aluminum, as well as other materials such as clay, terracotta, ceramic tile, brick, fiber cement, concrete, or stone such as slate.

In other embodiments of the present invention, various techniques can be employed to improve the properties of the resulting vitreous enamel coatings, including the use of high-purity silica sand (99.5-99.9%) in the primary frit to optimize one or more of optical reflectance and optical emissivity.

In other embodiments of the present invention, the underlying vitreous enamel coating containing multi-scale nanoparticles, has an additional overlying protective coating that is transparent to the frequency band of the solar sky window of the solar irradiation as defined in the above background section.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A coating for application to roof surfaces and siding surfaces to promote radiative cooling comprising:
one or more multi-scale highly reflective nanoparticles, wherein the coating is vitreous enamel coating and the vitreous enamel coating includes 2-40% of one or more highly reflective multi-scale nanoparticles of a total weight of the vitreous enamel coating.

2. The coating of claim 1, wherein one or more of the roof surfaces and the side surfaces are a metallic material.

3. The coating of claim 2, wherein the metallic material is selected from a group consisting of: steel, corrugated iron, cast iron, aluminum, zinc, tin, copper, metal admixtures, and metallic coatings.

4. The coating of claim 1, wherein one or more of the roof surfaces and the side surfaces are a nonmetallic material.

5. The coating of claim 4, wherein the nonmetallic material is selected from a group consisting of: clay, terracotta, ceramic tile, brick, fiber cement, concrete, stone and admixtures of nonmetal materials.

6. The coating of claim 1, wherein the one or more multi-scale highly reflective nanoparticles are barium sulfate (BaSO₄).

7. The coating of claim 1, wherein the one or more multi-scale highly reflective nanoparticles are hexagonal boron nitride (h-BN).

8. The coating of claim 1, wherein the one or more multi-scale highly reflective nanoparticles are zirconium silicate.

9. The coating of claim 1, wherein the one or more multi-scale highly reflective nanoparticles are titanium dioxide.

10. The coating of claim 1, wherein the one or more multi-scale highly reflective nanoparticles are: barium sulfate (BaSO₄), hexagonal boron nitride (h-BN), zirconium silicate (ZrSiO₄), and titanium dioxide (TiO₂).

11. The coating of claim 1, wherein the one or more multi-scale highly reflective nanoparticles are one or more of: barium sulfate (BaSO₄), hexagonal boron nitride (h-BN), zirconium silicate (ZrSiO₄), titanium dioxide (TiO₂), calcium carbonate (CaCO₃), zinc sulfide (ZnS), silicon dioxide (SiO₂), magnesium oxide (MgO), yttrium orthoaluminate (Al₅O₁₂Y₃), calcium oxide (CaO), magnesium aluminate (Al₂MgO₄), and lanthanum aluminate (LaAlO₃).

12. The coating of claim 1, wherein the one or more multi-scale highly reflective nanoparticles of the coating increase the reflectivity over a range of solar irradiation from infrared to ultraviolet.

13. The coating of claim 1, further comprising high purity silica sand, such that the high purity silica sand improves one or more of emissivity or reflectance of the coating.

14. The coating of claim 1, wherein the one or more multi-scale highly reflective nanoparticles has a distribution of nanoparticles of 10-900 nm.

15. The coating of claim 1, wherein the coating is an undercoat.

16. The coating of claim 1, wherein a baking temperature of the vitreous enamel coating is less than a melting point of the one or more highly reflective multi-scale nanoparticles.

17. The coating of claim 1, wherein the one or more multi-scale highly reflective nanoparticles are barium sulfate (BaSO₄) and hexagonal boron nitride (h-BN).

18. The coating of claim 1, wherein the coating further comprises thermochromic materials of vanadium dioxide (VO₂).

19. The coating of claim 1, wherein the coating is a cover coat.

20. The coating of claim 1, wherein the coating is a primary coating.

21. A method of applying a vitreous enamel coating to a substrate surface of a roof and/or siding comprising:
determine a type of coating to be applied and a thickness of the coating;
preparing a primary frit comprising one or more multi-scale highly reflective nanoparticles, wherein the primary frit includes 2-40% of one or more highly reflective multi-scale nanoparticles of a total weight of the vitreous enamel coating to be applied;
applying the primary frit to the substrate surface using a wet process or a dry process;
firing the substrate surface with the applied primary frit at a temperature below a melting point of the one or more multi-scale highly reflective nanoparticles at least once to apply a first coating to the substrate surface;
applying a second coating over the first coating; and
curing the substrate surface with the first coating and the second coating.

22. The method of claim 21, wherein prior to forming the frit, the substrate surface is prepared to receive the first coating.

23. The method of claim 21, wherein the first coating is a primary coating.

24. The method of claim 21, wherein the first coating is an undercoat.

25. The method of claim 21, wherein the second coating is clear coating.
